(19) United States
(12) Patent Application Publication
(10) Pub. No.: US 2017/0315839 A1
(43) Pub. Date: Nov. 2, 2017

(54) Method and Device for Processing Virtual Machine Migration

(71) Applicant: ZTE Corporation, Shenzhen (CN)

(72) Inventor: Maopeng ZHANG, Shenzhen (CN)

(21) Appl. No.: 15/521,369

(22) PCT Filed: Jul. 2, 2015
(86) PCT No.: PCT/CN2015/083188

§ 371 Date: Apr. 24, 2017

(30) Foreign Application Priority Data
Oct. 24, 2014 (CN) 201410578284.2

(51) Int. Cl. G06F 9/48; G06F 9/455

(52) U.S. Cl. CPC G06F 9/4856; G06F 9/455

(57) ABSTRACT

A method and device for processing virtual machine migration, the method includes that: migration information of at least one virtual machine is acquired; a migration path for migrating each of the at least one virtual machine is determined according to the acquired migration information; and each of the at least one virtual machine is migrated and gathered onto a host corresponding to the migration path according to the determined migration path.

### TECHNICAL FIELD

The disclosure relates to the field of computer, and in particular to a method and device for processing virtual machine migration.

### BACKGROUND

In a field of cloud calculating, a live migration (also called a dynamic migration or a real-time migration) of a virtual machine is to save or restore the virtual machine refers that a whole operation state of the virtual machine is completely saved and can simultaneously be restored to an original hardware platform and even to a different hardware platform. After restoration, the virtual machine still operates smoothly. The live migration in the related art is generally classified into five steps:

Step A: establishing a connection between a source computer and a target computer;

Step B: transferring configuration and device information of the virtual machine;

Step C: transferring a memory of the virtual machine;

Step D: pausing (suspending) the source virtual machine and transferring a state of the source virtual machine;

Step E: restoring the target virtual machine.

Moreover, Step D is the key for interruption time consumption, and packet loss may occur, causing a short interruption of upper layer service. If during a process of virtual machine migration and the virtual machine is processing a great amount of service, it may cause a time-out of the virtual machine migration and a migration failure. In a field of networking function virtualization, high real time capability and zero interruption, etc. are required for service. Thus, a problem in the related art that a long interruption time during the process of live migration of the virtual machine leads to packet loss.

For the problem in the related art that the long interruption time during the process of the live migration of at least one virtual machine leads to packet loss, an effective solution has not been proposed yet.

### SUMMARY

The embodiments of disclosure provide a method and device for processing virtual machine migration, so as to resolve a problem in the related art that long interruption time during a process of live migration of at least one virtual machine leads to packet loss.

In one embodiment of the disclosure, a method for processing virtual machine migration is provided, which includes that: acquiring migration information of at least one virtual machine; determining a migration path for migrating each of the at least one virtual machine according to the acquired migration information; and migrating and gathering each of the at least one virtual machine onto a host corresponding to the migration path according to the determined migration path.

In an example embodiment, the virtual machine migration information includes at least one of the following: at least one specification parameter of the host, currently operating remaining resources of the host, a number of at least one virtual machine operating on the host, at least one specification parameter of each virtual machine operating on the host, at least one migration restriction condition for restricting the virtual machine migration, and at least one virtual machine service live migration factor for representing migration difficulty of virtual machine service.

In an example embodiment, determining the migration path for migrating each of the at least one virtual machine according to the acquired migration information includes: calculating remaining resources of each host according to a number of at least one virtual machine operating on each host and at least one specification parameter of the host; acquiring at least one virtual machine service live migration factor and at least one migration restriction condition of the host, of which a number of the remaining resources is lower than a preset threshold; and determining the migration path for migrating each of the at least one virtual machine according to the calculated remaining resources of the host, the acquired at least one virtual machine service live migration factor and the acquired at least one migration restriction condition.

In an example embodiment, migrating and gathering the at least one virtual machine onto the host corresponding to the migration path according to the determined migration path includes: migrating service of the at least one virtual machine to the host corresponding to the migration path according to the migration path; and enabling the service of part or all of the at least one virtual machine on the host when the service of part or all of the at least one virtual machine is successfully migrated.

In an example embodiment, after migrating and gathering the at least one virtual machine onto the host corresponding to the migration path according to the determined migration path, including: closing at least one idle host.

In another embodiment of the disclosure, a device for processing virtual machine migration is provided, which includes that: an acquisition component, arranged to acquire the migration information of at least one virtual machine; a determination component, arranged to determine a migration path for migrating each of the at least one virtual machine according to the acquired migration information; and a migration component, arranged to migrate and gather each of the at least one virtual machine onto the host corresponding to the migration path according to the determined migration path.

In an example embodiment, the virtual machine migration information includes at least one of the following: at least one specification parameter of the hosts, currently operating remaining resources of the hosts, a number of at least one virtual machine operating on the host, at least one specification parameter of each virtual machine operating on the host, at least one migration restriction condition for restricting the virtual machine migration, and at least one virtual machine service live migration factor for representing migration difficulty of virtual machine service.

In an example embodiment, the determination component includes: a calculating element, arranged to calculate remaining resources of each host according to a number of at least one virtual machine operating on each host and at least one specification parameter of the hosts; an acquisition element, arranged to acquire at least one virtual machine service live migration factor and at least one migration restriction condition of the host, of which a number of the remaining resources is lower than a preset threshold; and a determination element, arranged to determine the migration path for migrating each of the at least one virtual machine according to the calculated remaining resources of the host, the acquired at least one virtual machine service live migration factor and the acquired at least one migration restriction condition.

In an example embodiment, the migrating component includes: a migration element, arranged to migrate service of the at least one virtual machine to the host corresponding to the migration path according to the migration path; and an enabling element, arranged to enable the service of part or all of the at least one virtual machine on the host when the service of part or all of the at least one virtual machine is successfully migrated.

In an example embodiment, the device further includes: a closing component, arranged to close at least one idle host.

Through the disclosure, the migration information of the at least one virtual machine is acquired, and the migration path for migrating each of the at least one virtual machine is determined according to the acquired migration information; each of the at least one virtual machine is migrated and gathered onto the host corresponding to the migration path according to the determined migration path. The problem in the related art that the long interruption time during the process of live migration of at least one virtual machine leads to packet loss is solved, and the at least one virtual machine which is dispersed on various hosts are migrated and gathered onto the host acquired resulting from calculating, thus effects of green and energy saving and no service interruption are reached.

### BRIEF DESCRIPTION OF THE DRAWINGS

The figures, forming a part of the application, are intended to provide further understanding of the invention. The schematic embodiments and illustrations of the invention are intended to explain the invention, and do not form improper limits to the invention. In the figures:

FIG. 1 is a flowchart of a method for processing virtual migration according to an embodiment of the disclosure;

FIG. 2 is a structural block diagram of a device for processing virtual machine migration according to an embodiment of the disclosure;

FIG. 3 is a structural block diagram of a device for processing virtual machine migration according to a first embodiment of the disclosure;

FIG. 4 is a structural block diagram of a device for processing virtual machine migration according to a second embodiment of the disclosure;

FIG. 5 is a structural block diagram of a device for processing virtual machine migration according to a third embodiment of the disclosure;

FIG. 6 is a flowchart of a method for processing virtual machine migration according to an example embodiment of the disclosure;

FIG. 7 is a flowchart of cooperation between various components according to an example embodiment of the disclosure.

### DETAILED DESCRIPTION

It is important to note that the embodiments in the application and the characteristics in the embodiments may be combined under the condition of no conflicts. The invention will be described below with reference to the figures and in combination with the embodiments in detail.

The steps shown in the flowcharts of the figures can be executed in computer system such as a set of computer-executable instruments. Furthermore, although there are logic sequences in the flowcharts, in some circumstances, sequences different from the steps shown or described here can be executed.

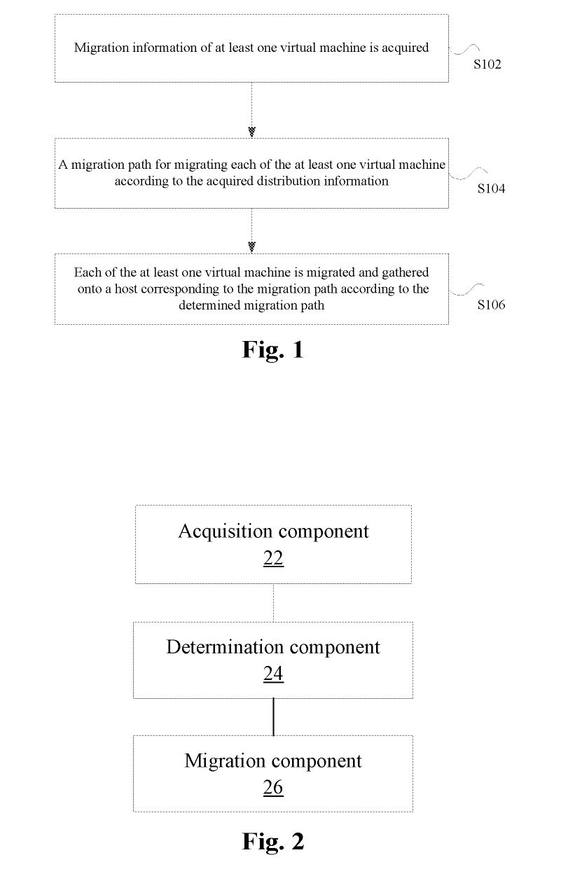

The embodiment provides a method for processing virtual machine migration, and FIG. 1 is a flowchart of a method for processing virtual migration according to an embodiment of the disclosure. As shown in FIG. 1, the method includes the following steps:

Step S102: migration information of at least one virtual machine is acquired;

Step S104: a migration path for migrating each of the at least one virtual machine according to the acquired distribution information;

Step S106: each of the at least one virtual machine is migrated and gathered onto a host corresponding to the migration path according to the determined migration path.

Through the embodiment of the disclosure, the migration path for migrating each of the at least one virtual machine is determined according to the migration information of the at least one virtual machine, and each of the at least one virtual machine is migrated and gathered onto the host corresponding to the migration path according to the determined migration path. The problem in the related art that the long interruption time during the process of live migration of at least one virtual machine leads to packet loss is solved, and the at least one virtual machine which is dispersed on various hosts are migrated and gathered onto the host acquired resulting from calculating, thus effects of green and energy saving and no service interruption are reached.

The migration information of the embodiment may includes the following: at least one specification parameter of the host, currently operating remaining resources of the host, a number of at least one virtual machine operating on the host, at least one specification parameter of each virtual machine operating on the host, at least one migration restriction condition for restricting the virtual machine migration, and at least one virtual machine live migration factor for representing migration difficulty of virtual machine service.

In an implementation of the embodiment, determine the migration path for migrating each of the at least one virtual machine according to the acquired distribution information alternatively can be realized through the following steps:

Step S1: remaining resources of each host is calculated according to a number of at least one virtual machine operating on each host and at least one specification parameter of the host;

Step S2: at least one virtual machine service live migration factor of the host, of which a number of the remaining resources is lower than a preset threshold, is acquired;

Step S3: the migration path for migrating each of the at least one virtual machine is determined according to the calculated remaining resources of the host, the acquired at least one virtual machine service live migration factor and the acquired at least one migration restriction condition.

In the embodiment, ways of migrating and gathering the at least one virtual machine onto the host corresponding to the migration path according to the determined migration path are various, and it is realized through the following way in an implementation of the embodiment:

Step S11: service of the at least one virtual machine is migrated to the host corresponding to the migration path according to the migration path;

Step S12: the service of part or all of the at least one virtual machine on the host is enabled when the service of part or all of the at least one virtual machine is successfully migrated.

After Step S106 of the embodiment, the method further includes: at least one idle host is closed.

The embodiment of the disclosure further provides a device for processing virtual machine migration, which is used for realizing the above-mentioned embodiment of the disclosure. FIG. 2 is a structural block diagram of a device for processing virtual machine migration according to an embodiment of the disclosure. As shown in FIG. 2, the device includes: an acquisition component 22, arranged to acquire the migration information of at least one virtual machine; a determination component 24 coupled with the acquisition component 22 and arranged to determine a migration path for migrating each of the at least one virtual machine according to the acquired migration information; a migration component 26 coupled with the acquisition component 22 and arranged to migrate and gather each of the at least one virtual machine onto the host corresponding to the migration path according to the determined migration path.

It is important to note that the virtual machine migration information of the embodiment includes, but not limited to, at least one of the following: at least one specification parameter of the hosts, currently operating remaining resources of the hosts, a number of at least one virtual machine operating on the host, at least one specification parameter of each virtual machine operating on the host, at least one migration restriction condition for restricting the virtual machine migration, and at least one virtual machine service live migration factor for representing migration difficulty of virtual machine service.

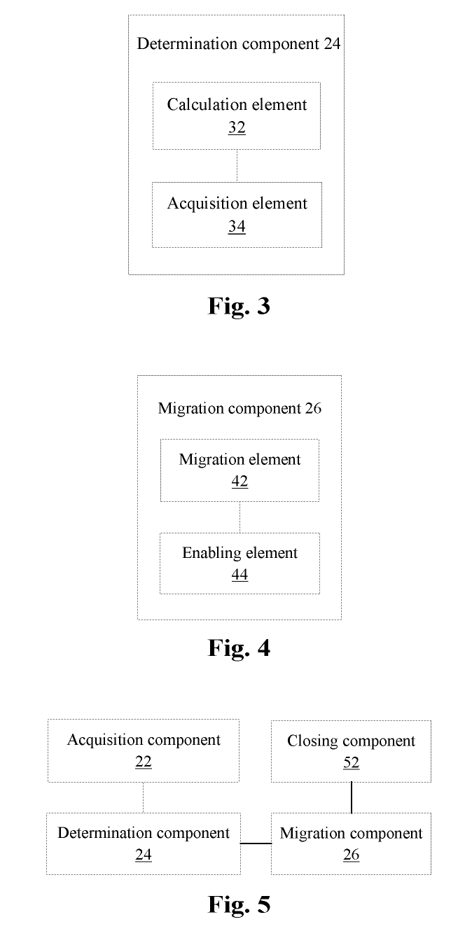

FIG. 3 is a structural block diagram of a device for processing virtual machine migration according to a first embodiment of the disclosure. As shown in FIG. 3, the determination component 24 includes: a calculating element 32, arranged to calculate remaining resources of each host according to a number of at least one virtual machine operating on each host and at least one specification parameter of the hosts; an acquisition element 34 coupled with the calculating element 32 and arranged to acquire at least one virtual machine service live migration factor and at least one migration restriction condition of the host, of which a number of the remaining resources is lower than a preset threshold; a determination element 36 coupled with the acquisition element 34 and arranged to determine the migration path for migrating each of the at least one virtual machine according to the calculated remaining resources of the host, the acquired at least one virtual machine service live migration factor and the acquired at least one migration restriction condition.

FIG. 4 is a structural block diagram of a device for processing virtual machine migration according to a second embodiment of the disclosure. As shown in FIG. 4, the migration component 26 includes: a migration element 42, arranged to migrate service of the at least one virtual machine to the host corresponding to the migration path according to the migration path; an enabling element 44 coupled with the migration element 42 and arranged to enable the service of part or all of the at least one virtual machine on the host when the service of part or all of the at least one virtual machine is successfully migrated.

FIG. 5 is a structural block diagram of a device for processing virtual machine migration according to a third embodiment of the disclosure. As shown in FIG. 5, the device further includes: a closing component 52 coupled with the migration component 26 and arranged to close at least one idle host.

It is important to note that the device for processing the virtual machine migration described in the embodiment of device corresponds to the above-mentioned embodiment of method, and it shall not be described again since its specific realising process is detailed in the embodiment of method.

The disclosure is described below with reference to the accompanying figures and embodiments.

The main idea of the invention in the alternative embodiment of the disclosure is: a Network Functions Virtualisation Orchestrator (NFVO) automatically monitors the distribution of at least one virtual machine on the host through a Virtualised Infrastructure Manager (VIM), selects an optimal migration path according to the at least one specification parameter of each virtual machine, at least one specification parameter of the host and at least one virtual machine service live migration factor, and cooperates the virtual machine service with a Virtualized Network Function (VNF). Then, the at least one virtual machine is migrated and gathered, and finally the at least one virtual machine dispersed on various hosts are rationally migrated to the host acquired resulting from calculating, thus the effects of green and energy saving and no service interruption are reached.

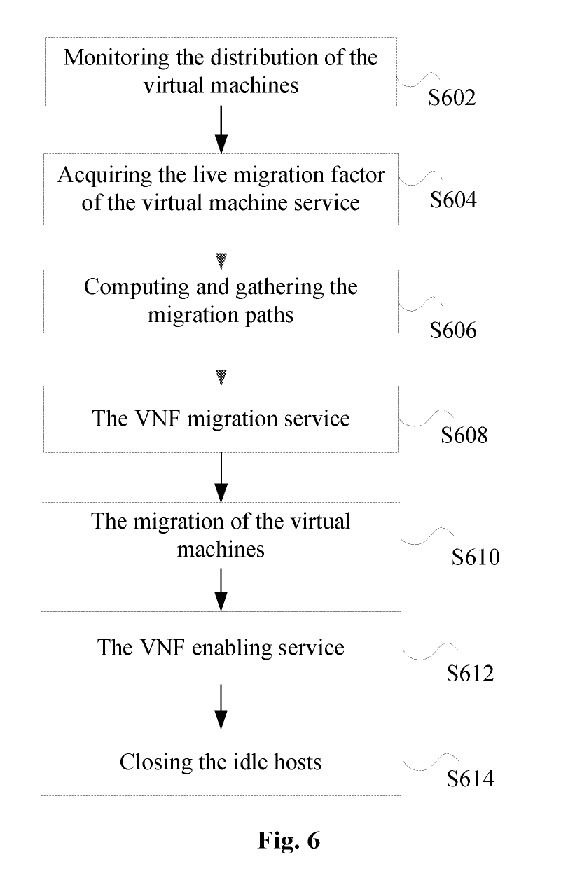

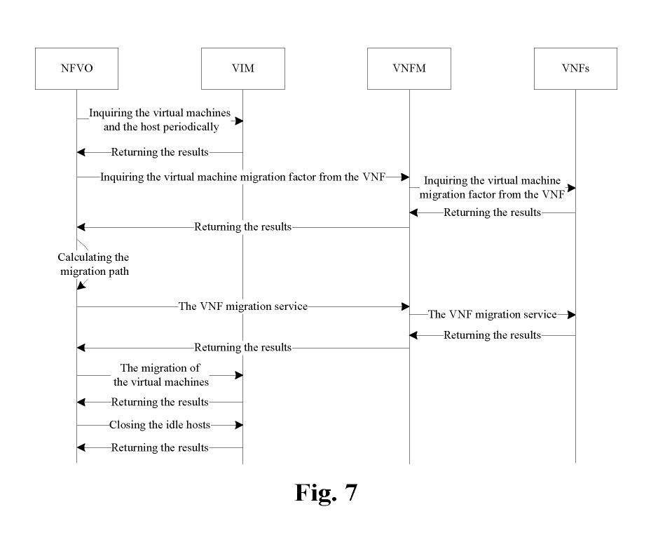

In an alternative embodiment, a method for processing the virtual machine migration is provided, and FIG. 6 is a flowchart of a method for processing virtual machine migration according to an example embodiment of the disclosure. As shown in FIG. 6, the alternative embodiment of the disclosure includes:

Step S602: a distribution of at least one virtual machine is monitored;

The NFVO obtains at least one specification parameter of the host and at least one specification parameter of each virtual machine through VIM, including parameters such as CPU, memory, hard disk, etc. and network connection; moreover, the corresponding data shall be dynamically and synchronously upgraded after operations such as VNF deployment, flexibility and termination, etc.

Step S604: at least one live migration factor of the virtual machine service is acquired.

Moreover, the NFVO interacts with the related VNF through a Virtualized Network Function Manager (VNFM), and returns all current live migration factors of the virtual machine service according to the amount of current service.

Step S606: the migration path for each virtual machine is calculated and gathered.

Moreover, all migration schemes which can be selected by the virtual machines are listed generally according the remaining resources of the host and the specification of the current virtual machines, the restricting requirements such as the affinity of the virtual machines, etc. and the live migration factor of the virtual machine service. The migration schemes include the migration schemes automatic calculated or manually adjusted according to the above-mentioned conditions.

Step S608: the VNF migration service.

Wherein, the NFVO notifies the VNF to perform the migration of the service on the virtual machines according to the migration scheme generated in Step S606 through VNFM.

Step S610: the migration of the at least one virtual machine is performed.

Moreover, the NFVP performs the migration of the virtual machines according to the migration scheme according to Step S606 through the VIM after the VNF service migration. The migration of the virtual machines does not limit to the live migration, and it further includes cold migration or other form of migration.

Step S612: the VNF enables service.

Moreover, the virtual machines are in operation again and accept new service through the interaction of the VNFM and the VNF after the NFVO completes the migration of the virtual machines.

Step S614: at least one idle host is closed;

Moreover, NFVO closes the idle hosts through the VIM after the gathering of the virtual machines.

Compared with the related art, the alternative embodiment of the disclosure proposes a virtual machine gathering method based on uninterrupted VNF. It has an advantage of uninterrupted service relative to the virtual machine live migration technology sole through VIM in the related art, and the algorithm is more precise since the service migration overhead is considered on the basis of the VIM for the calculating of migration path.

The implementation of the technical solution of the disclosure will be further described below in detail with reference to FIG. 7 and in combination with the specific embodiments. FIG. 7 is a flowchart of cooperation between various components according to an example embodiment of the disclosure.

Alternative embodiment one: monitoring the distribution of the virtual machines on the host;

In the alternative embodiment one, two mechanisms for monitoring the distribution of the at least one virtual machine on the host, periodical and timely change, are provided, and the steps include:

Step S701: the NFVO is normally started and at least one virtual machine operating on each host is inquired through the VIM periodically.

Step S702: the change of the at least one virtual machine is monitored during a life cycle management process of the NS and the VNF, and changing the corresponding distribution when change occurs.

Step S703: the specification of the operating host and the restriction that has a influence on the virtual machine migration, etc. are recorded in the NFVO.

Step S704: the specification of the operating host and the related migration restriction, such as the affinity and exclusion relationship of the virtual machines, etc. are recorded in the NFVO.

Step S705: the virtual machines operating on the host are recorded in the NFVO; Alternative embodiment two: selecting an optimal gathering path; In the alternative embodiment two, the optimal gathering path is determined according to the current distribution of the virtual machines on the host, and the steps include:

Step S711: the NFVO analyses the number and specification of the virtual machines operating on the current host, and calculates the remaining resources of the host. The host with no remaining resources is filtered to obtain the related VNF and the virtual machines.

Step S712: the NFVO, through VNFM, acquires the live migration factor of the virtual machine service that may be migrated in the current VNF from the related VNF.

Step S713: the related VNF, according to the current amount of service, returns the live migration factor of the virtual machine service that may be migrated, which represents the migration difficulty of the service in the at least one virtual machine. For example, for 0-1, 0 represents the easiest, while 1 represents the most difficult; however, it does not limit to such an expressing way.

Step S714: the optimal gathering path is acquired according to the virtual machine live migration factor of the virtual machine distribution, restriction and migration; the specific gathering algorithm is not limited.

Step S715: Human effort can further be involved in the adjustment of gathering path. If there is remaining hosts, the implementation shall be continued, otherwise it shall be ended.

Alternative embodiment three: gathering of at least one virtual machine;

In the alternative embodiment three, the virtual machine migration with the service uninterrupted is completed according to the gathering path, and the steps include:

Step S721: the NFVO notifies the VNF to perform the migration of the service in the at least one virtual machine through the VNFM;

Step S722: the VNF notifies the VNFM and further notifies the NFVO after completing the migration of the service in the at least one virtual machine;

Step S723: the VNF perform the virtual machine migration through the VIM;

Step S724: the NFVO, through the VNFM, enables the virtual machine service migrated by the VNF.

Moreover, in Steps S721-S723, the at least one virtual machines can be in series and all the virtual machines can be executed one by one; further, the virtual machines may belongs to one VNF or the whole virtual machine migration may be performed after all virtual machine service migration completed.

Step S725: the NFVO closes at least one idle host through the VIM.

It is important to note that, the step may be closed after one host migrates all the virtual machines or may be closed after the migration of all the virtual machines are completed, which are not limited herein.

In the network function virtualization, the resources used by VNF can be defined according to software, and the virtual machine may be stretched elastically according to need. Under the condition that the system is in continuous operation, the virtual resource is continuously stretching elastically: when the service load is rising, the system flexibility grows and the virtual machines increase; when the service load is dropping, the virtual machines decrease. In the process of increasing and decreasing the virtual machines, the distribution of the virtual machines on the host is continuously showing a discretization trend. With the discretization of the distribution of the virtual machines on the host, multiple hosts would have a low operating load, causing the energy consumption increase. The alternative embodiments of the disclosure, on the premise of ensuring the service uninterrupted, gather the virtual machines used by the VNF on the physical host, close the redundant hosts and reach the object of energy conservation and pollution reduction.

The above is only the example embodiments of the invention, and not intended to limit the invention. There can be various modifications and variations in the invention for those skilled in the art. Any modifications, equivalent replacements, improvements and the like made within the spirit and principle of the invention shall fall within the scope of protection of the invention.

### INDUSTRIAL APPLICABILITY

Through the above-mentioned technical solution provided in the embodiments of the disclosure, the migration information of the at least one virtual machine is acquired, and the migration path for migrating each of the at least one virtual machine is determined according to the acquired migration information; each of the at least one virtual machine is migrated and gathered onto the host corresponding to the migration path according to the determined migration path. The problem in the related art that the long interruption time during the process of live migration of at least one virtual machine leads to packet loss is solved, and the at least one virtual machine which is dispersed on various hosts are migrated and gathered onto the host acquired resulting from calculating, thus effects of green and energy saving and no service interruption are reached.

1. A method for processing virtual machine migration, comprising:
acquiring migration information of at least one virtual machine;
determining a migration path for migrating each of the at least one virtual machine according to the acquired migration information; and
migrating and gathering each of the at least one virtual machine onto a host corresponding to the migration path according to the determined migration path.

2. The method as claimed in claim 1, wherein, the virtual machine migration information comprises at least one of the following:
at least one specification parameter of the host, currently operating remaining resources of the host, a number of at least one virtual machine operating on the host, at least one specification parameter of each virtual machine operating on the host, at least one migration restriction condition for restricting the virtual machine migration, and at least one virtual machine service live migration factor for representing migration difficulty of virtual machine service.

3. The method as claimed in claim 2, wherein, determining the migration path for migrating each of the at least one virtual machine according to the acquired migration information comprises:
calculating remaining resources of each host according to a number of at least one virtual machine operating on each host and at least one specification parameter of the host;
acquiring at least one virtual machine service live migration factor and at least one migration restriction condition of the host, of which a number of the remaining resources is lower than a preset threshold; and
determining the migration path for migrating each of the at least one virtual machine according to the calculated remaining resources of the host, the acquired at least one virtual machine service live migration factor and the acquired at least one migration restriction condition.

4. The method as claimed in claim 1, wherein, migrating and gathering the at least one virtual machine onto the host corresponding to the migration path according to the determined migration path comprises:
migrating service of the at least one virtual machine to the host corresponding to the migration path according to the migration path; and
enabling the service of part or all of the at least one virtual machine on the host when the service of part or all of the at least one virtual machine is successfully migrated.

5. The method as claimed in claim 1, wherein, after migrating and gathering the at least one virtual machine onto the host corresponding to the migration path according to the determined migration path, comprising:
closing at least one idle host.

6. An device for processing virtual machine migration, comprising:
an acquisition component, arranged to acquire the migration information of at least one virtual machine;
a determination component, arranged to determine a migration path for migrating each of the at least one virtual machine according to the acquired migration information; and
a migration component, arranged to migrate and gather each of the at least one virtual machine onto the host corresponding to the migration path according to the determined migration path.

7. The device as claimed in claim 6, wherein, the virtual machine migration information comprises at least one of the following:
at least one specification parameter of the hosts, currently operating remaining resources of the hosts, a number of at least one virtual machine operating on the host, at least one specification parameter of each virtual machine operating on the host, at least one migration restriction condition for restricting the virtual machine migration, and at least one virtual machine service live migration factor for representing migration difficulty of virtual machine service.

8. The device as claimed in claim 7, wherein, the determination component comprises:
a calculating element, arranged to calculate remaining resources of each host according to a number of at least one virtual machine operating on each host and at least one specification parameter of the hosts;
an acquisition element, arranged to acquire at least one virtual machine service live migration factor and at least one migration restriction condition of the host, of which a number of the remaining resources is lower than a preset threshold; and
a determination element, arranged to determine the migration path for migrating each of the at least one virtual machine according to the calculated remaining resources of the host, the acquired at least one virtual machine service live migration factor and the acquired at least one migration restriction condition.

9. The device as claimed in claim 6, wherein the migrating component comprises:
a migration element, arranged to migrate service of the at least one virtual machine to the host corresponding to the migration path according to the migration path; and
an enabling element, arranged to enable the service of part or all of the at least one virtual machine on the host when the service of part or all of the at least one virtual machine is successfully migrated.

10. The device as claimed in claim 6, wherein, the device further comprises:
a closing component, arranged to close at least one idle host.
